(19) United States
(12) Patent Application Publication
(10) Pub. No.: US 2020/0127850 A1
(43) Pub. Date: Apr. 23, 2020

(54) CERTIFYING A TRUSTED PLATFORM MODULE WITHOUT PRIVACY CERTIFICATION AUTHORITY INFRASTRUCTURE

(71) Applicant: Intel Corporation, Santa Clara, CA (US)

(72) Inventors: Vincent Scarlata, Beaverton, OR (US); Bin Xing, Hillsboro, OR (US); Reshma Lal, Portland, OR (US); Salessawi Ferede Yitbarek, Hillsboro, OR (US); Shanwei Cen, Portland, OR (US)

(73) Assignee: Intel Corporation, Santa Clara, CA (US)

(21) Appl. No.: 16/722,234

(22) Filed: Dec. 20, 2019

(51) Int. Cl. H04L 9/32; G06F 21/53; H04L 9/30

(52) U.S. Cl. CPC H04L 9/3247; G06F 21/53; H04L 9/3234; H04L 9/3242; G06F 2221/033; H04L 9/30

(57) ABSTRACT

A method comprises receiving, in a trusted execution environment (TEE), an attestation public key and one or more endorsement credentials for a trusted platform module, inspecting the one or more endorsement credentials for the trusted platform module, generating an attestation that the attestation public key resides within the trusted platform module identified by the one or more endorsement credentials, the attestation comprising at least a portion of the public attestation key, encrypting, in the trusted execution environment, at least a component of the attestation to generate an attestation key activation blob, forwarding the attestation key activation blob to the platform module, and receiving, from the platform module, a response that varies based on whether at least a portion of the public attestation key in the attestation key activation blob matches a public attestation key on the platform module.

### BACKGROUND

Current processors may provide support for a trusted execution environment such as a secure enclave. Secure enclaves include segments of memory (including code and/or data) protected by the processor from unauthorized access including unauthorized reads and writes. For example, certain processors may include Intel® Software Guard Extensions (SGX) to provide secure enclave support. In particular, SGX provides confidentiality, integrity, and replay-protection to the secure enclave data while the data is resident in the platform memory and thus provides protection against both software and hardware attacks. The on-chip boundary forms a natural security boundary, where data and code may be stored in plaintext and assumed to be secure. Intel® SGX does not protect I/O data that moves across the on-chip boundary.

In a cloud computing system, confidential information is stored, transmitted, and used by many different information processing systems. Existing security techniques do not adequately address the issue of securing data in a cloud network.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified schematic diagram of an example system including an attestation system in accordance with an embodiment.

FIG. 2 is a simplified block diagram of an example system including an example platform supporting secure enclaves in accordance with an embodiment.

FIG. 3 is a simplified block diagram representing application attestation in accordance with one embodiment.

FIG. 4 is a simplified block diagram of at least one embodiment of a computing system which may be adapted to implement a method for certifying a trusted platform module (TPM) without privacy infrastructure according to an embodiment.

FIG. 5 is a simplified data flow diagram of at least one embodiment of a method for certifying a trusted platform module (TPM) without privacy infrastructure according to an embodiment.

FIG. 6 is a simplified operational flow diagram of at least one embodiment of a method for certifying a trusted platform module (TPM) without privacy infrastructure according to an embodiment.

FIG. 7 is a simplified operational flow diagram of at least one embodiment of a method for certifying a trusted platform module (TPM) without privacy infrastructure according to an embodiment.

FIG. 8 is a block diagram illustrating a computing architecture which may be adapted to provide a method for certifying a trusted platform module (TPM) without privacy infrastructure according to an embodiment.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C) Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Example Attestation Environment

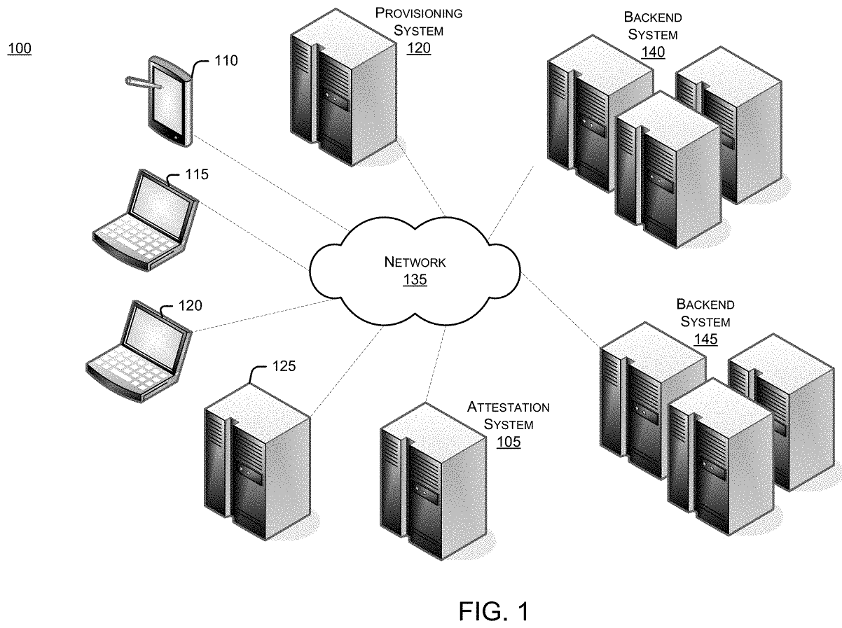

FIG. 1 is a simplified block diagram illustrating an example embodiment of a computing environment 100 including an example attestation system 105. The attestation system 105 can receive data, or “quotes,” generated by secured logical components, or enclaves, running on host systems (e.g., 110, 115, 120, 125) to attest to the authenticity and security (and other characteristics) of another application or enclave of the host and confirm the attestation based on the received quote. The quote can be signed or include data that has been signed by a cryptographic key, cipher, or other element (collectively referred to herein as “keys”) from which the attestation system can authenticate or confirm the trustworthiness of the quote (and thereby also the application or enclave attested to by the quote). Such keys can be referred to as attestation keys. A provisioning system 120 can be utilized to securely provision such attestation keys on the various host devices 110, 115, 120, 125.

In some cases, attestation can be carried out in connection with a client-server or frontend-backend interaction (e.g., over one or more networks 125) between an application hosted on a host system (e.g., 110, 115, 120, 125) and a backend service hosted by a remote backend system (e.g., 140, 145). Sensitive data and transaction can take place in such interactions and the application can attest to its trustworthiness and security to the backend system (and vice versa) using an attestation system (e.g., 105). In some implementations, the attestation system itself can be hosted on the backend system. In other cases, a backend system (e.g., 140) (or even another host device in a peer-to-peer attestation) can consume the attestation services of a separate attestation system (e.g., 105).

In some examples a provisioning system can maintain a database of certificates mapped to various host devices (e.g., 110, 115, 120, 125) equipped with hardware and software to implement trusted execution environments, or secure enclaves. Each of the certificates can be derived from keys that are themselves based on persistently maintained, secure secrets provisioned on the host devices (e.g., 110, 115, 120, 125) during manufacture. The secrets remain secret to the host device and may be implemented as fuses, a code in secure persistent memory, among other implementations. The key may be the secret itself or a key derived from the secret. The certificate may not identify the key and the key may not be derivable from the certificate, however, signatures produced by the key may be identified as originating from a particular one of the host devices for which a certificate is maintained based on the corresponding certificate. In this manner, a host device (e.g., 110, 115, 120, 125) can authenticate to the provisioning system 120 and be provided (by the provisioning system 120) with an attestation key that is securely associated with the host device. These attestation keys can then be used by secure enclaves on the corresponding host device (e.g., 110, 115, 120, 125) to attest to one or more applications or enclaves present on the host device.

Networks 125, in some implementations, can include local and wide area networks, wireless and wireline networks, public and private networks, and any other communication network enabling communication between the systems.

In general, “servers,” “devices,” “computing devices,” “host devices,” “user devices,” “clients,” “servers,” “computers,” “platform,” “environment,” “systems,” etc. (e.g., 105, 110, 115, 120, 125, 120, 140, 145, etc.) can include electronic computing devices operable to receive, transmit, process, store, or manage data and information associated with the computing environment 100. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems. Computing devices may be further equipped with communication modules to facilitate communication with other computing devices over one or more networks (e.g., 125). Such networks 125 may include local and wide area networks, wireless and wireline networks, public and private networks, and any other communication network enabling communication between systems.

Host devices (e.g., 110, 115, 120, 125) can further computing devices implemented as one or more local and/or remote client or end user devices, such as application servers, personal computers, laptops, smartphones, tablet computers, personal digital assistants, media clients, web-enabled televisions, telepresence systems, gaming systems, multimedia servers, set top boxes, smart appliances, in-vehicle computing systems, and other devices adapted to receive, view, compose, send, or otherwise interact with, access, manipulate, consume, or otherwise use applications, programs, and services served or provided through servers within or outside the respective device (or environment 100). A host device can include any computing device operable to connect or communicate at least with servers, other host devices, networks, and/or other devices using a wireline or wireless connection. A host device, in some instances, can further include at least one graphical display device and user interfaces, including touchscreen displays, allowing a user to view and interact with graphical user interfaces of applications, tools, services, and other software of provided in environment 100. It will be understood that there may be any number of host devices associated with environment 100, as well as any number of host devices external to environment 100. Further, the term “host device,” “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers, among other examples.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

An attestation is a signed assertion reflecting information such as 1) what software is running within an enclave; 2) who signed the assertion and the version information; 3) the hardware information and hardware trusted computing base (TCB); and information from the enclave (e.g., trusted key). In embodiments, each platform has a certified attestation key for signing attestations on behalf of the platform.

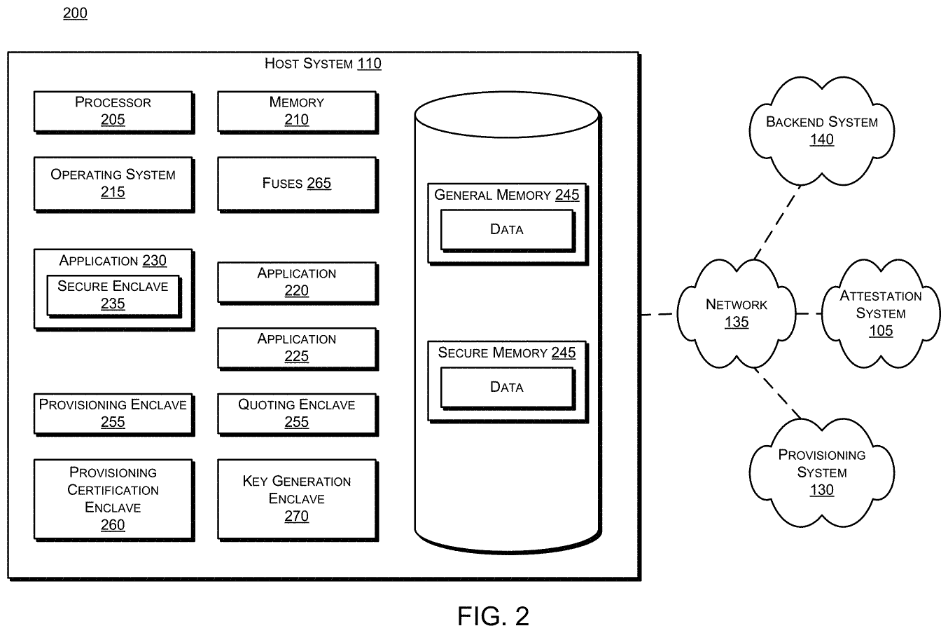

Turning to the example of FIG. 2, a simplified block diagram 200 is shown illustrating a system or computing environment that includes a host system 110 equipped to support one or more secure enclaves (e.g., 235, 250, 255, 260, 265). A host system 110 can include one or more processor devices 205, one or more memory elements 210, and other components implemented in hardware and/or software, including an operating system 215 and a set of applications (e.g., 220, 225, 230). One or more of the applications may be secured using a secure enclave 235, or application enclave. Secure enclaves can be implemented in secure memory 240 (as opposed to general memory 245) and utilizing secured processing functionality of at least one of the processors (e.g., 205) of the host system to implement private regions of code and data to provide certain secured or protected functionality of the application. Logic, implemented in firmware and/or software of the host system (such as code of the CPU of the host), can be provided on the host system 110 that can be utilized by applications or other code local to the host system to set aside private regions of code and data, which are subject to guarantees of heightened security, to implement one or more secure enclaves on the system. For instance, a secure enclave can be used to protect sensitive data from unauthorized access or modification by rogue software running at higher privilege levels and preserve the confidentiality and integrity of sensitive code and data without disrupting the ability of legitimate system software to schedule and manage the use of platform resources. Secure enclaves can enable applications to define secure regions of code and data that maintain confidentiality even when an attacker has physical control of the platform and can conduct direct attacks on memory. Secure enclaves can further allow consumers of the host devices (e.g., 110) to retain control of their platforms including the freedom to install and uninstall applications and services as they choose. Secure enclaves can also enable a host system platform to measure a corresponding application's trusted code and produce a signed attestation, rooted in the processor, that includes this measurement and other certification that the code has been correctly initialized in a trustable environment (and is capable of providing the security features of a secure enclave, such as outlined in the examples above). Generally, secure enclaves (and other secured enclaves described herein) can adopt or build upon principles described, for instance, in the Intel® Software Guard Extensions Programming Reference, among other example platforms.

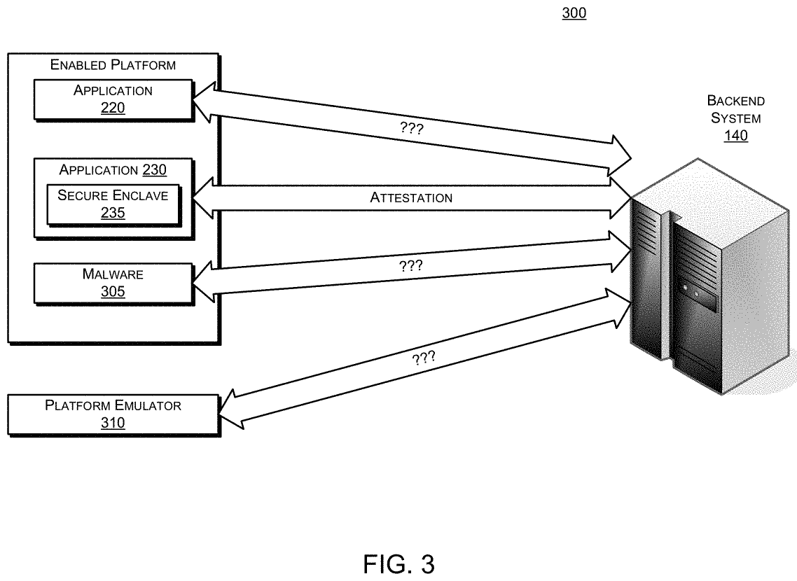

Turning briefly to FIG. 3, an application enclave (e.g., 235) can protect all or a portion of a given application 230 and allow the application 230 (and its security features) to be attested to. For instance, a service provider in backend system 140, such as a backend service or web service, may prefer or require that clients with which it interfaces, possess certain security features or guarantees, such that the service 140 can verify that it is transacting with who it the client says it is. For instance, malware (e.g., 305) can sometimes be constructed to spoof the identity of a user or an application in an attempt to extract sensitive data from, infect, or otherwise behave maliciously in a transaction with the service 140. Signed attestation (or simply “attestation”) can allow an application (e.g., 230) to verify that it is a legitimate instance of the application (i.e., and not malware). Other applications (e.g., 220) that are not equipped with a secure application enclave may be legitimate, but may not attest to the service provider 140, leaving the service provide in doubt, to some degree, of the application's authenticity and trustworthiness. Further, host system platforms (e.g., 110) can be emulated (e.g., by emulator 310) to attempt to transact falsely with the service 140. Attestation through a secure enclave can guard against such insecure, malicious, and faulty transactions.

Returning to FIG. 2, attestation can be provided on the basis of a signed piece of data, or “quote,” that is signed using an attestation key securely provisioned on the platform. In some examples a developer partitions an application into a portion that requires security and a portion that does not require security. For example, code that implements a graphic interface that controls video playback doesn't need to be trusted, but code that decrypts and processes a video file does require security. In this example the developer puts the security sensitive portions in the enclave and the untrusted portion remains outside the enclave. Secured enclaves can sign a measurement (included in a quote) and assist in the provisioning of one or more of the enclaves with keys for use in signing the quote and established secured communication channels between enclaves or between an enclave and an outside service (e.g., 105, 120, 140). For instance, one or more provisioning enclaves 250 can be provided to interface with a corresponding provisioning system to obtain attestation keys for use by a quoting enclave 255 and/or application enclave. One or more quoting enclaves 255 can be provided to sign a measurement of an application enclave 235 with the attestation key obtained through the corresponding provisioning enclave 250. A provisioning certification enclave 260 may also be provided to authenticate a provisioning enclave (e.g., 250) to its corresponding provisioning system (e.g., 120). The provisioning certification enclave 260 can maintain a provisioning attestation key that is based on a persistently maintained, secure secret on the host platform 110, such as a secret set in fuses 265 of the platform during manufacturing, to support attestation of the trustworthiness of the provisioning enclave 250 to the provisioning system 120, such that the provisioning enclave 250 is authenticated prior to the provisioning system 120 entrusting the provisioning enclave 250 with an attestation key. In some implementations, the provisioning certification enclave 260 can attest to authenticity and security of any one of potentially multiple provisioning enclaves 250 provided on the platform 110. For instance, multiple different provisioning enclaves 250 can be provided, each interfacing with its own respective provisioning system, providing its own respective attestation keys to one of potentially multiple quoting enclaves (e.g., 255) provided on the platform. For instance, different application enclaves can utilize different quoting enclaves during attestation of the corresponding application, and each quoting enclave can utilize a different attestation key to support the attestation. Further, through the use of multiple provisioning enclaves and provisioning services, different key types and encryption technologies can be used in connection with the attestation of different applications and services (e.g., hosted by backend systems 140).

In some implementations, rather than obtaining an attestation key from a remote service (e.g., provisioning system 120), one or more applications and quoting enclaves can utilize keys generated by a key generation enclave 270 provided on the platform. In other examples the TEE (i.e., SGX) provides an EGETKEY instruction to instruct hardware to generate a persistent key that will be available in future boot operations. The quoting enclave 255 can use this to create a value that can be used to create a signing key and the provisioning certification enclave (PCE) 260 can sign that key exactly as you have described here, however, without the needing an extra key generation enclave, rather the quoting enclave 255 itself plays both roles. To attest to the reliability of the key provided by the key generation enclave 270, the provisioning certification enclave 260 can sign the key (e.g., the public key of a key pair generated randomly by the key generation enclave) such that quotes signed by the key can be identified as legitimately signed quotes.

### Example Computing Device

As described above, in a cloud computing system, confidential information is stored, transmitted, and used by many different information processing systems. An attestation environment such as the environment described with reference to FIGS. 1-3 utilize a remote certificate authority accessible over a network (i.e., the Internet, frequently referred to as a Privacy Certificate Authority, in the attestation process. In cloud computing environments, this means that either 1) servers are calling out to a third-party service, which may introduce unacceptable security risks, or 2) the cloud service provider must host a Privacy Certificate Authority, which, in turn, requires that customers must trust the cloud service providers. Described herein are structures and techniques which allow for attestation of a Trusted Platform Module (TPM) without a Privacy Certificate Authority or the associated infrastructure. This enables cloud service providers to build a system that use Trusted Platform Module in which customers don't have to trust the cloud service provider to implement a Privacy Certificate Authority.

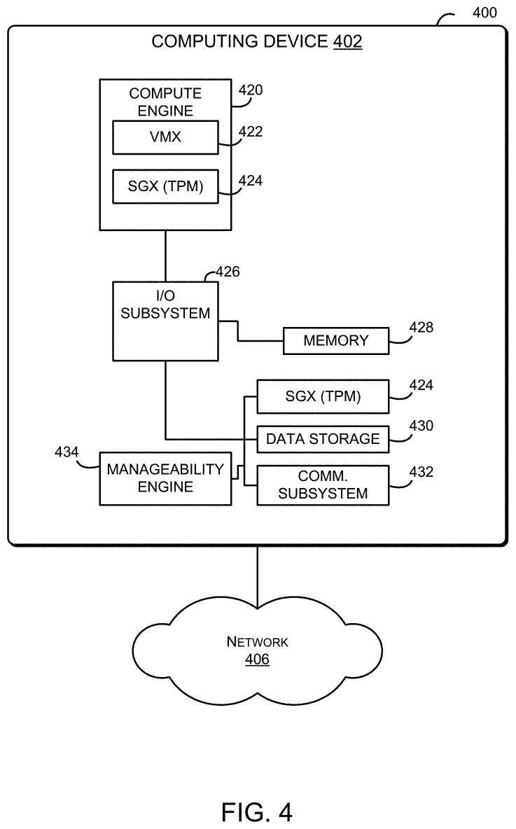

FIG. 4 is a simplified block diagram of at least one embodiment of a computing system which may be adapted to implement a method for certifying a Trusted Platform Module (TPM) without privacy infrastructure according to an embodiment. Referring now to FIG. 4, a computer system 400 which may be adapted to implement a method for certifying a trusted platform module (TPM) without privacy infrastructure includes a computing device 402 The computing device 402 may be embodied as any type of device capable of performing the functions described herein. For example, the computing device 402 may be embodied as, without limitation, a switch, a router, a network device, a computer, a mobile computing device, a server, a workstation, a multiprocessor system, a distributed computing device, and/or a consumer electronic device. Additionally, or alternatively, the computing device 402 may be embodied as a one or more compute sleds, memory sleds, or other racks, sleds, computing chassis, or other components of a physically disaggregated computing device. As shown in FIG. 4, the illustrative computing device 402 includes a compute engine 420, an I/O subsystem 426, a memory 428, a data storage device 430, and a communication subsystem 432. Additionally, in some embodiments, one or more of the illustrative components may be incorporated in, or otherwise form a portion of, another component. For example, the memory 428, or portions thereof, may be incorporated in the compute engine 420 in some embodiments.

The compute engine 420 may be embodied as any type of compute engine capable of performing the functions described herein. For example, the compute engine 420 may be embodied as a single or multi-core processor(s), digital signal processor, microcontroller, field-programmable gate array (FPGA), or other configurable circuitry, application-specific integrated circuit (ASIC), or other processor or processing/controlling circuit. The compute engine 420 may comprise a VMX support 422. The VMX support 422 supports virtualized execution of operating systems by providing two modes of execution: VMX root mode and VMX non-root mode. The VMX root mode allows executing software to have broad control of the computing device 402 and its hardware resources. Accordingly, a virtual machine monitor (VMM), hypervisor, or host operating system may execute in VMX root mode. The VMX non-root mode restricts access to certain hardware instructions while still implementing the ordinary ring/privilege system of the compute engine 420. Thus, one or more guest virtual machines (VMs) and/or guest operating systems (OSs) may execute in the VMX non-root mode. Those guest OSs may execute in ring zero, similar to execution without virtualization. The execution of certain hardware instructions and certain other system events may trigger hardware-assisted transitions to VMX root mode. Those hardware-assisted transitions are commonly known as virtual machine exits (VM exits) or hypercalls. Upon encountering a VM exit, the compute engine 420 may switch context from the guest VM to the VMM in order to handle the VM exit. The VMX support 422 may be embodied as, for example, Intel VT-x technology and/or Intel VT-d technology.

The compute device 402 also includes secure enclave support 424, which allows the compute engine 420 to establish a trusted execution environment in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the compute engine 420 while being executed or while being stored in certain protected cache memory of the compute engine 420. The code and data included in the secure enclave may be encrypted when stored in a shared cache or the main memory 428. The secure enclave support 424 may be embodied as a set of processor instruction extensions that allows the compute engine 420 to establish one or more secure enclaves in the memory 428. For example, the secure enclave support 424 may be embodied as Intel Software Guard Extensions (SGX) technology.

The memory 428 may be embodied as any type of volatile or non-volatile memory or data storage capable of performing the functions described herein. In operation, the memory 428 may store various data and software used during operation of the computing device 402 such as operating systems, applications, programs, libraries, and drivers. As shown, the memory 428 may be communicatively coupled to the compute engine 420 via the I/O subsystem 426, which may be embodied as circuitry and/or components to facilitate input/output operations with the compute engine 420, the memory 428, and other components of the computing device 402. For example, the I/O subsystem 426 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 428 may be directly coupled to the compute engine 420, for example via an integrated memory controller hub. Additionally, in some embodiments, the I/O subsystem 426 may form a portion of a system-on-a-chip (SoC) and be incorporated, along with the compute engine 420, the memory 428, and/or other components of the computing device 402, on a single integrated circuit chip.

The data storage device 430 may be embodied as any type of device or devices configured for short-term or long-term storage of data such as, for example, memory devices and circuits, memory cards, hard disk drives, solid-state drives, non-volatile flash memory, or other data storage devices. The communications subsystem 432 may be embodied as any communication circuit, device, or collection thereof, capable of enabling communications between the computing device 402 and other remote devices over the network 406. The communications subsystem 432 may be configured to use any one or more communication technology (e.g., wired or wireless communications) and associated protocols (e.g., Ethernet, Bluetooth®, Wi-Fi®, WiMAX, 3G, 4G LTE, 5G, etc.) to effect such communication.

As discussed in more detail below, the computing device 402 may be configured to transmit and receive data with each other and/or other devices of the system 400 over the network 406. The network 406 may be embodied as any number of various wired and/or wireless networks. For example, the network 406 may be embodied as, or otherwise include a mobile access network, a network edge infrastructure, a wired or wireless local area network (LAN), and/or a wired or wireless wide area network (WAN). As such, the network 406 may include any number of additional devices, such as additional base stations, access points, computers, routers, and switches, to facilitate communications among the devices of the system 400. In the illustrative embodiment, the network 406 is embodied as an edge network fabric.

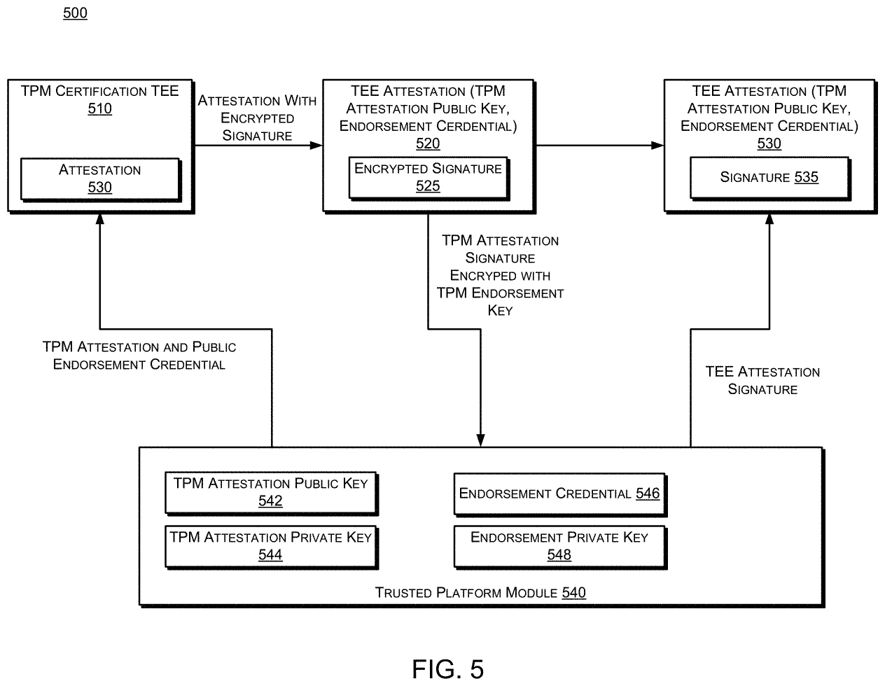

Having described various structures and components for certifying a trusted platform module (TPM) without privacy infrastructure, operations and data flows will now be described with reference to FIGS. 5-7. As used herein the following terms shall apply:

The phrase “TEE Attestation” shall refer to a signed statement about a TEE indicating the measurements of the TEE and a statement from that TEE, such as “I can be contacted via public key X” or “I have verified that X is true about key Y.”

The phrase “TEE Attestation Key” shall refer to a cryptographic key that is used to sign TEE attestations. It has a certificate chain back to a trusted authority such as the manufacturer indicating that the hardware making the attestation statement is trustworthy.

The phrase “TPM Attestation Key” shall refer to a cryptographic key that is used by the TPM to sign measurements in the TPM.

The phrase “Endorsement Key” shall refer to the TPM's root identity key. It can be used to decrypt identity activation blobs.

The phrase “Endorsement Credentials” shall refer to a Certificate typically generated by the TPM manufacturer indicating that the enclosed Endorsement Key was placed in a valid TPM.

The phrase “Attestation Key Activation Blob” shall refer to a data blob that contains a value, encrypted to the Endorsement key of a TPM referencing a specific TPM Attestation Key.

FIG. 5 is a simplified data flow diagram of at least one embodiment of a method for certifying a trusted platform module (TPM) without privacy certificate authority infrastructure according to an embodiment. In brief overview, a method for certifying a trusted platform module such as TPM 540 depicted in FIG. 5 may be implemented between the TPM 540 and a trusted execution environment such as TEE 510. TPM 540 may maintain both a TPM attestation public key 542 and a TPM private key 544. TPM 540 may also maintain an endorsement credential 546 and an endorsement private key 548. The TPM Certification TEE 510 may implement operations that enable the TEE 510 to attest that it has verified that the TPM attestation key 544 resides within the TPM 540.

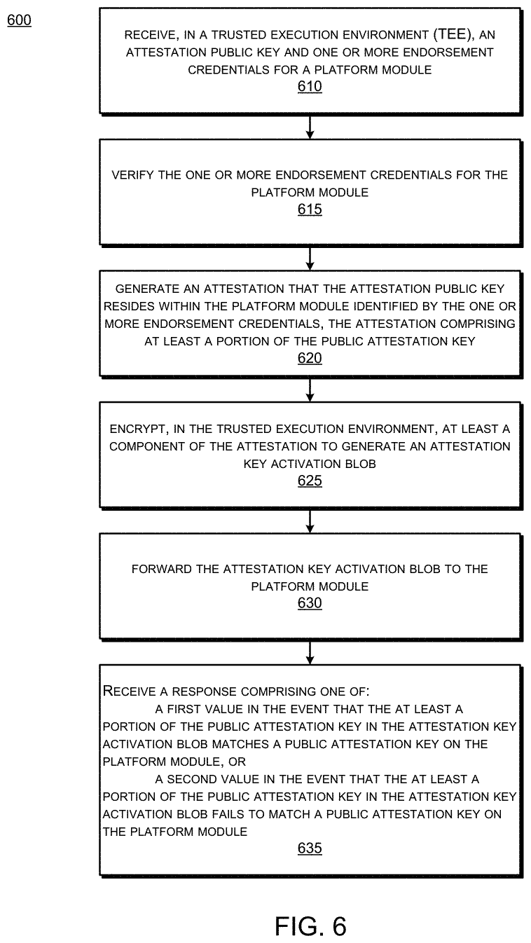

Referring now to FIG. 6, in operation, a computing device may execute a method 600 for certifying a trusted platform module (TPM) without privacy infrastructure according to an embodiment secure memory-mapped I/O (MMIO) write requests. It should be appreciated that, in some embodiments, the operations of the method 600 may be performed by one or more components of the computing device, such as the trusted platform module (TPM) trusted execution environment (TEE) 510 and a trusted platform module (TPM) 540 associated with SGX 424.

Referring to FIG. 6, at operation 610 a trusted execution environment (TEE) such as TEE 510 receives an attestation public key 542 and one or more endorsement credentials 546 for a platform such as a trusted platform module (TPM) 540. In some examples software resident on the platform sends the attestation public key 542 and the endorsement credential 546 from the TPM 540 to the TEE 510. The TEE 510 may reside on the same platform as the TPM 540 or on a different platform.

At operation 615 the TEE 510 verifies the one or more endorsement credentials for the TMP 540. Verification of the endorsement credentials may include verification of the signature on the credentials, verification of the issuer of the credentials based on additional credentials, application of certificate revocation lists, or other operations to ensure the credentials represent genuine hardware. In some examples, this operation may be omitted, and left to the Attestation Service to verify while processing a TPM Attestation.

At operation 620 the TEE 510 generates a TEE attestation asserting that the TPM attestation public key 542 resides within the TPM 540 that is identified by the endorsement credential 546. In some examples the attestation comprises at least a portion of the TPM public attestation key 542. In some examples the attestation also comprises one or more endorsement keys or credentials. At operation 625 the TPM creates an attestation key activation blob by encrypting a component of the attestation generated in operation 620 with an encrypted signature 525. In some examples the component that is encrypted depends on the TEE 510. In some examples (i.e., SGX or other TEEs) either the signature on the Attestation or the entire Attestation. In some examples this can be the message authentication code (MAC) on an EREPORT or the entire REPORT. SGX Reports are an intermediate structure that is then delivered to a Quoting Enclave, which converts it into an Attestation/Quote. I may have forgotten to mention that specifically operation 615 can be done either by the TEE or can be done much later by whoever if verifying a TPM attestation. In some examples the Endorsement Key may be included in the attestation in operation 620.

At operation 630 the attestation key activation blob is forwarded to the TPM 540. In some examples software on the platform provides the attestation key activation blob to the TPM 540 using a TPM_ActivateIdentity command. Upon receiving the attestation key activation blob, the TPM 540 decrypts the blob to extract the component of the attestation key included in the blob. If the component of the attestation key received from the TEE 510 is not in the TPM 540, then the TPM discards the credential and returns a response to the TEE 510 that includes an error. By contrast, if the component of the attestation key received from the TEE 510 is in the TPM 540, then the TPM 540 decrypts the contents of the activation blob and returns it to software executing on the platform, which routed to the TEE 510.

At operation 635 the TEE 510 or other support software receives the output generated by the TPM 540. The output comprises a first value in the event that the component of the attestation key received from the TEE 510 matches a corresponding portion of the attestation key in the TPM 540. By contrast, the output comprises a second value in the event that the component of the attestation key received from the TEE 510 fails to match a corresponding portion of the attestation key in the TPM 540.

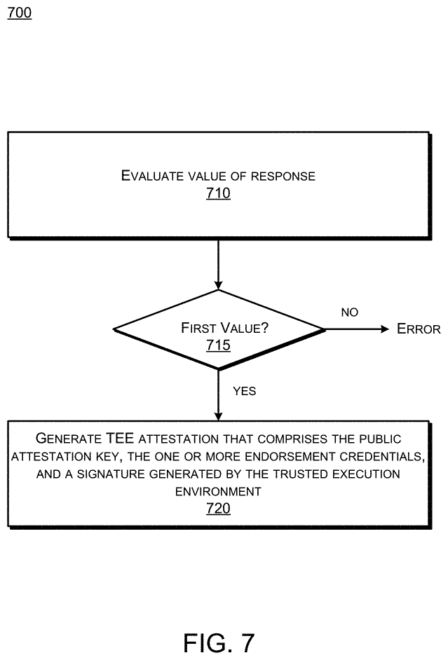

Referring now to FIG. 7, at operation 710 the TEE 510 or other support software evaluates the value of the response output from the TPM 540. If, at operation 715, the output is not the first value then an error condition occurs. By contrast, if at operation 715 the value of the response output from the TPM 540 is the first value then control passes to operation 720 and software reconstructs the TEE attestation 530 comprising the signature 535 originally created by TEE 510 in 620 that can be used by any verifier to determine that the TPM Certification TEE 510 participated in the TPM certification protocol and guarantees that TPM Attestation Key is in the same device as the included Endorsement Key.

### Exemplary Computing Architecture

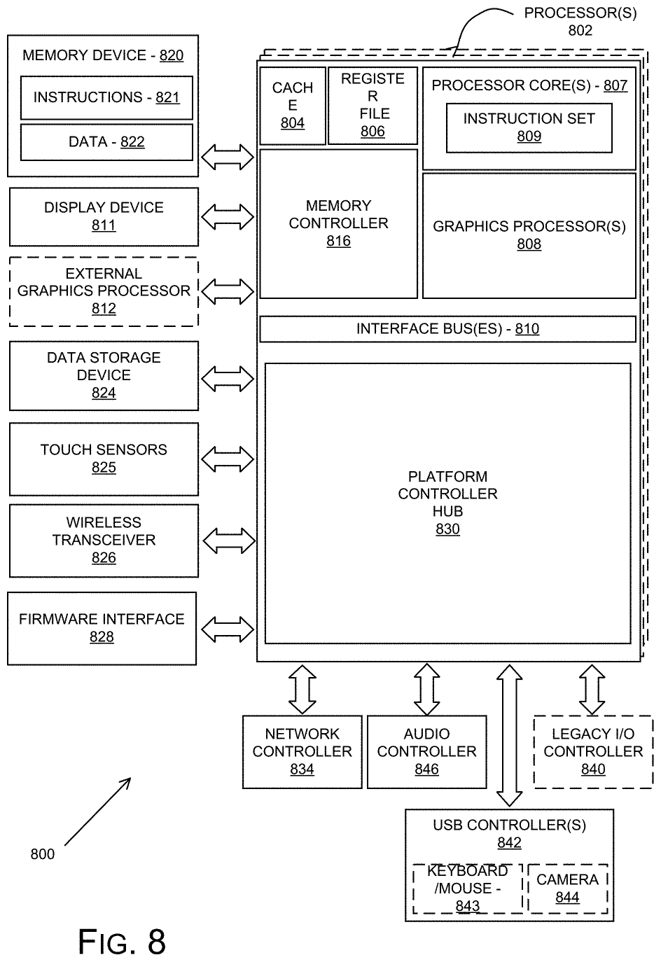

FIG. 8 is a block diagram illustrating a computing architecture which may be adapted to implement a secure address translation service using a permission table (e.g., HPT 135 or HPT 260) and based on a context of a requesting device in accordance with some examples. The embodiments may include a computing architecture supporting one or more of (i) verification of access permissions for a translated request prior to allowing a memory operation to proceed; (ii) prefetching of page permission entries of an HPT responsive to a translation request; and (iii) facilitating dynamic building of the HPT page permissions by system software as described above.

In various embodiments, the computing architecture 800 may comprise or be implemented as part of an electronic device. In some embodiments, the computing architecture 800 may be representative, for example, of a computer system that implements one or more components of the operating environments described above. In some embodiments, computing architecture 800 may be representative of one or more portions or components in support of a secure address translation service that implements one or more techniques described herein.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within, a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 814. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, one or more processor(s) 802 are coupled with one or more interface bus(es) 810 to transmit communication signals such as address, data, or control signals between processor 802 and other components in the system. The interface bus 810, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 802 include an integrated memory controller 816 and a platform controller hub 830. The memory controller 816 facilitates communication between a memory device and other components of the system 800, while the platform controller hub (PCH) 830 provides connections to I/O devices via a local I/O bus.

Memory device 820 can be a dynamic random-access memory (DRAM) device, a static random-access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 execute an application or process. Memory controller hub 816 also couples with an optional external graphics processor 812, which may communicate with the one or more graphics processors 808 in processors 802 to perform graphics and media operations. In some embodiments a display device 811 can connect to the processor(s) 802. The display device 811 can be one or more of an internal display device, as in a mobile electronic device or a laptop device or an external display device attached via a display interface (e.g., DisplayPort, etc.). In one embodiment the display device 811 can be a head mounted display (HMD) such as a stereoscopic display device for use in virtual reality (VR) applications or augmented reality (AR) applications.

In some embodiments the platform controller hub 830 enables peripherals to connect to memory device 820 and processor 802 via a high-speed I/O bus. The I/O peripherals include, but are not limited to, an audio controller 846, a network controller 834, a firmware interface 828, a wireless transceiver 826, touch sensors 825, a data storage device 824 (e.g., hard disk drive, flash memory, etc.). The data storage device 824 can connect via a storage interface (e.g., SATA) or via a peripheral bus, such as a Peripheral Component Interconnect bus (e.g., PCI, PCI Express). The touch sensors 825 can include touch screen sensors, pressure sensors, or fingerprint sensors. The wireless transceiver 826 can be a Wi-Fi transceiver, a Bluetooth transceiver, or a mobile network transceiver such as a 3G, 4G, Long Term Evolution (LTE), or 5G transceiver. The firmware interface 828 enables communication with system firmware, and can be, for example, a unified extensible firmware interface (UEFI). The network controller 834 can enable a network connection to a wired network. In some embodiments, a high-performance network controller (not shown) couples with the interface bus 810. The audio controller 846, in one embodiment, is a multi-channel high definition audio controller. In one embodiment the system 800 includes an optional legacy I/O controller 840 for coupling legacy (e.g., Personal System 2 (PS/2)) devices to the system. The platform controller hub 830 can also connect to one or more Universal Serial Bus (USB) controllers 842 connect input devices, such as keyboard and mouse 843 combinations, a camera 844, or other USB input devices.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Example 1 is method comprising receiving, in a trusted execution environment (TEE), a first attestation public key representing a trusted platform module, and one or more endorsement credentials for the trusted platform module; inspecting the one or more endorsement credentials for the trusted platform module; using a second attestation key representing the TEE to generate an attestation that the first attestation public key resides within the trusted platform module identified by the one or more endorsement credentials, the attestation comprising at least a portion of the public attestation key; encrypting, in the trusted execution environment, at least a component of the attestation to generate an attestation key activation blob; forwarding the attestation key activation blob to the trusted platform module; and receiving, from the trusted platform module, a response comprising one of: a first value in the event that the at least a portion of the public attestation key in the attestation key activation blob matches a public attestation key on the trusted platform module, or a second value in the event that the at least a portion of the public attestation key in the attestation key activation blob fails to match a public attestation key on the platform module.

Example 2 includes the subject matter of Example 1, further comprising reconstructing a TEE attestation in the event the response from the trusted platform module comprises the first value.

Example 3 includes the subject matter of Examples 1-2, wherein the TEE attestation comprises the public attestation key, the one or more endorsement credentials, and a signature generated by the trusted execution environment.

Example 4 includes the subject matter of Examples 1-3, wherein the attestation key activation blob comprises at least one of a signature on the attestation or the entire attestation.

Example 5 includes the subject matter of Examples 1-4, further comprising generating a report comprising at least a portion of the attestation key activation blob; and sending the report to a quoting enclave.

Example 6 includes the subject matter of Examples 1-5, wherein the attestation key activation blob comprises at least one of a message authentication code (MAC) or a portion of the report generated by the trusted execution environment.

Example 7 includes the subject matter of Examples 1-6 wherein the trusted execution environment and the trusted platform module reside on the same platform.

Example 8 is an apparatus, comprising a processor; and a computer readable memory comprising instructions which, when executed by the processor, cause the processor to receive, in a trusted execution environment (TEE), a first attestation public key representing a trusted platform module, and one or more endorsement credentials for the trusted platform module; inspect the one or more endorsement credentials for the trusted platform module; use a second attestation key representing the TEE to generate an attestation that the first attestation public key resides within the trusted platform module identified by the one or more endorsement credentials, the attestation comprising at least a portion of the public attestation key; encrypt, in the trusted execution environment, at least a component of the attestation to generate an attestation key activation blob; forward the attestation key activation blob to the trusted platform module; and receive, from the trusted platform module, a response comprising one of a first value in the event that the at least a portion of the public attestation key in the attestation key activation blob matches a public attestation key on the trusted platform module, or a second value in the event that the at least a portion of the public attestation key in the attestation key activation blob fails to match a public attestation key on the platform module.

Example 9 includes the subject matter of Example 8, further comprising comprising instructions which, when executed by the processor, cause the processor to generate a TEE attestation in the event the response from the trusted platform module comprises the first value.

Example 10 includes the subject matter of Examples 8-9 and further wherein the TEE attestation comprises the public attestation key, the one or more endorsement credentials, and a signature generated by the trusted execution environment.

Example 11 includes the subject matter of Examples 8-10, wherein the attestation key activation blob comprises at least one of a signature on the attestation or the entire attestation.

Example 12 includes the subject matter of Examples 8-11, further comprising instructions which, when executed by the processor, cause the processor to generate a report comprising at least a portion of the attestation key activation blob; and send the report to a quoting enclave.

Example 13 includes the subject matter of Examples 8-12, wherein the attestation key activation blob comprises at least one of a message authentication code (MAC) or a portion of the report generated by the trusted execution environment.

Example 14 includes the subject matter of Examples 8-13, wherein the trusted execution environment and the trusted platform module reside on the same platform.

Example 15 is ine more computer-readable storage media comprising instructions stored thereon that, in response to being executed, cause a computing device to receive, in a trusted execution environment (TEE), a first attestation public key representing a trusted platform module, and one or more endorsement credentials for the trusted platform module; inspect the one or more endorsement credentials for the trusted platform module; use a second attestation key representing the TEE to generate an attestation that the first attestation public key resides within the trusted platform module identified by the one or more endorsement credentials, the attestation comprising at least a portion of the public attestation key; encrypt, in the trusted execution environment, at least a component of the attestation to generate an attestation key activation blob; forward the attestation key activation blob to the trusted platform module; and receive, from the trusted platform module, a response comprising one of a first value in the event that the at least a portion of the public attestation key in the attestation key activation blob matches a public attestation key on the trusted platform module, or a second value in the event that the at least a portion of the public attestation key in the attestation key activation blob fails to match a public attestation key on the platform module.

Example 16 includes the subject matter of Examples 13-15, further comprising instructions stored thereon that, in response to being executed, cause the computing device to generate a TEE attestation in the event the response from the trusted platform module comprises the first value.

Example 17 includes the subject matter of Examples 15-16, wherein the TEE attestation comprises the public attestation key, the one or more endorsement credentials, and a signature generated by the trusted execution environment.

Example 18 includes the subject matter of Examples 15-17, wherein the attestation key activation blob comprises at least one of a signature on the attestation or the entire attestation.

Example 19 includes the subject matter of Examples 15-18, further comprising instructions stored thereon that, in response to being executed, cause the computing device to generate a report comprising at least a portion of the attestation key activation blob; and send the report to a quoting enclave.

Example 20 includes the subject matter of Examples 15-19, wherein the attestation key activation blob comprises at least one of a message authentication code (MAC) or a portion of the report generated by the trusted execution environment.

Example 21 includes the subject matter of Examples 15-20, wherein the trusted execution environment and the trusted platform module reside on the same platform.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. A method comprising:
receiving, in a trusted execution environment (TEE), a first attestation public key representing a trusted platform module, and one or more endorsement credentials for the trusted platform module;
inspecting the one or more endorsement credentials for the trusted platform module;
using a second attestation key representing the TEE to generate an attestation that the first attestation public key resides within the trusted platform module identified by the one or more endorsement credentials, the attestation comprising at least a portion of the public attestation key;
encrypting, in the trusted execution environment, at least a component of the attestation to generate an attestation key activation blob;
forwarding the attestation key activation blob to the trusted platform module; and
receiving, from the trusted platform module, a response comprising one of:
a first value in the event that the at least a portion of the public attestation key in the attestation key activation blob matches a public attestation key on the trusted platform module, or
a second value in the event that the at least a portion of the public attestation key in the attestation key activation blob fails to match a public attestation key on the platform module.

2. The method of claim 1, further comprising:
reconstructing a TEE attestation in the event the response from the trusted platform module comprises the first value.

3. The method of claim 2, wherein the TEE attestation comprises the public attestation key, the one or more endorsement credentials, and a signature generated by the trusted execution environment.

4. The method of claim 1, wherein the attestation key activation blob comprises at least one of a signature on the attestation or the entire attestation.

5. The method of claim 1, further comprising:
generating a report comprising at least a portion of the attestation key activation blob; and
sending the report to a quoting enclave.

6. The method of claim 5, wherein the attestation key activation blob comprises at least one of a message authentication code (MAC) or a portion of the report generated by the trusted execution environment.

7. The method of claim 1, wherein:
the trusted execution environment and the trusted platform module reside on the same platform.

8. An apparatus comprising:
a processor; and
a computer readable memory comprising instructions which, when executed by the processor, cause the processor to:
receive, in a trusted execution environment (TEE), a first attestation public key representing a trusted platform module, and one or more endorsement credentials for the trusted platform module;
inspect the one or more endorsement credentials for the trusted platform module;
use a second attestation key representing the TEE to generate an attestation that the first attestation public key resides within the trusted platform module identified by the one or more endorsement credentials, the attestation comprising at least a portion of the public attestation key;
encrypt, in the trusted execution environment, at least a component of the attestation to generate an attestation key activation blob;
forward the attestation key activation blob to the trusted platform module; and
receive, from the trusted platform module, a response comprising one of:
a first value in the event that the at least a portion of the public attestation key in the attestation key activation blob matches a public attestation key on the trusted platform module, or
a second value in the event that the at least a portion of the public attestation key in the attestation key activation blob fails to match a public attestation key on the platform module.

9. The apparatus of claim 8, comprising instructions which, when executed by the processor, cause the processor to:
generate a TEE attestation in the event the response from the trusted platform module comprises the first value.

10. The apparatus of claim 9, wherein the TEE attestation comprises the public attestation key, the one or more endorsement credentials, and a signature generated by the trusted execution environment.

11. The apparatus of claim 8, wherein the attestation key activation blob comprises at least one of a signature on the attestation or the entire attestation.

12. The apparatus of claim 8, comprising instructions which, when executed by the processor, cause the processor to
generate a report comprising at least a portion of the attestation key activation blob; and
send the report to a quoting enclave.

13. The apparatus of claim 12, wherein the attestation key activation blob comprises at least one of a message authentication code (MAC) or a portion of the report generated by the trusted execution environment.

14. The apparatus of claim 8, wherein:
the trusted execution environment and the trusted platform module reside on the same platform.

15. One or more computer-readable storage media comprising instructions stored thereon that, in response to being executed, cause a computing device to:
receive, in a trusted execution environment (TEE), a first attestation public key representing a trusted platform module, and one or more endorsement credentials for the trusted platform module;
inspect the one or more endorsement credentials for the trusted platform module;
use a second attestation key representing the TEE to generate an attestation that the first attestation public key resides within the trusted platform module identified by the one or more endorsement credentials, the attestation comprising at least a portion of the public attestation key;
encrypt, in the trusted execution environment, at least a component of the attestation to generate an attestation key activation blob;
forward the attestation key activation blob to the trusted platform module; and
receive, from the trusted platform module, a response comprising one of:
a first value in the event that the at least a portion of the public attestation key in the attestation key activation blob matches a public attestation key on the trusted platform module, or
a second value in the event that the at least a portion of the public attestation key in the attestation key activation blob fails to match a public attestation key on the platform module.

16. The one or more computer-readable storage media of claim 16, further comprising instructions stored thereon that, in response to being executed, cause the computing device to:
generate a TEE attestation in the event the response from the trusted platform module comprises the first value.

17. The one or more computer-readable storage media of claim 15, wherein the TEE attestation comprises the public attestation key, the one or more endorsement credentials, and a signature generated by the trusted execution environment.

18. The one or more computer-readable storage media of claim 15, wherein the attestation key activation blob comprises at least one of a signature on the attestation or the entire attestation.

19. The one or more computer-readable storage media of claim 19, further comprising instructions stored thereon that, in response to being executed, cause the computing device to
generate a report comprising at least a portion of the attestation key activation blob; and
send the report to a quoting enclave.

20. The one or more computer-readable storage media of claim 19, wherein the attestation key activation blob comprises at least one of a message authentication code (MAC) or a portion of the report generated by the trusted execution environment.

21. The one or more computer-readable storage media of claim 15, wherein:
the trusted execution environment and the trusted platform module reside on the same platform.
